(19) United States
(12) Patent Application Publication
(10) Pub. No.: US 2011/0307106 A1
(43) Pub. Date: Dec. 15, 2011

(54) Methods and Systems for Monitoring, Controlling, and Recording Performance of a Storm Water Runoff Network

(76) Inventors: Kevin Charles Dutt, Newton Center, MA (US); John Randolph Eggleston, Brookline, MA (US)

(21) Appl. No.: 13/159,050

(22) Filed: Jun. 13, 2011

Related U.S. Application Data
(60) Provisional application No. 61/354,596, filed on Jun. 14, 2010.

(51) Int. Cl. G05D 7/06

(52) U.S. Cl. 700/282

(57) ABSTRACT

A method for monitoring, controlling, and recording performance of a storm water runoff network includes receiving, by a storm water management component, environmental data associated with a storage node. The method includes analyzing, by the storm water management component, the received environmental data. The method includes modifying, by the storm water management component, an operation of the storage node, responsive to the analysis. The method includes modifying, by the storm water management component, a state of a valve in the storage node, responsive to the analysis. The method includes modifying, by the storm water management component, a state of a pump in the storage node, responsive to the analysis. The method includes modifying, by the storm water management component, a state of a gate in the storage node, responsive to the analysis.

### CROSS-REFERENCE TO RELATED APPLICATIONS

This application claims priority from U.S. Provisional Patent Application Ser. No. 61/354,596, filed on Jun. 14, 2010, entitled “Networked Water Harvesting and Control System,” which is hereby incorporated by reference.

### BACKGROUND

The disclosure relates to methods and systems for managing storm water runoff networks. More particularly, the methods and systems described herein relate to monitoring, controlling, and recording performance of a storm water runoff network.

Storm water is precipitation and snowmelt that runs off impervious and land surfaces and into storm drains rather than being absorbed into the soil. Impervious surfaces such as roofs, driveways, sidewalks, and streets prevent storm water runoff from naturally soaking into the ground. As water flows over these surfaces it can pick up debris, chemicals, sediment, and other pollutants, and when it eventually empties into lakes, streams, rivers, wetlands, or coastal waters (either directly or through water-handling infrastructure, such as a storm sewer system), it contaminates these water bodies. Typically, water from a storm sewer system is discharged untreated into surface waters that may be used for swimming, fishing, and drinking water.

Expanding the capacity of existing drainage systems to reduce storm water runoff involves considerable expense and disruption. As land becomes more developed, more impervious surfaces are being added to communities, increasing storm water runoff and causing greater flooding and surface water pollution. Ultimately, increased storm water runoff leads to the need for investment in expensive storm water management infrastructure projects. At the same time, precipitation is a valuable source of relatively clean water. The inability of most current runoff systems to harvest water for reuse squanders a resource whose use would effectively increase the value of the system.

### BRIEF SUMMARY

In one aspect, a method for monitoring, controlling, and recording performance of a storm water runoff network includes receiving, by a storm water management component, environmental data associated with a storage node. The method includes analyzing, by the storm water management component, the received environmental data. The method includes modifying, by the storm water management component, an operation of the storage node, responsive to the analysis. The method includes modifying, by the storm water management component, a state of a valve in the storage node, responsive to the analysis. The method includes modifying, by the storm water management component, a state of a pump in the storage node, responsive to the analysis. The method includes modifying, by the storm water management component, a state of a gate in the storage node, responsive to the analysis.

In another aspect, a system for monitoring, controlling, and recording performance of a storm water runoff network includes a communications module, an analysis engine, and a command module. The communication module executes on a computing device and receives environmental data associated with a storage node. The analysis engine executes on the computing device, analyzes the received environmental data, and identifies a setting for the storage node. The command module executes on the computing device and directs the execution of a command to set the storage node to the identified setting responsive to the analysis.

In still another aspect, a system for monitoring, controlling, and recording performance of a storm water runoff network includes a storage node and a storm water management component. The storage node stores runoff. The storage node includes at least one monitoring sensor collecting environmental data associated with the storage node. In one embodiment, the at least one monitoring sensor collects operational data associated with the storage node. The storage node includes a controller executing a command to operate the storage node. In one embodiment, the storage node includes a communications module, in communication with the controller and with the storm water management component, that receives, from the storm water management component, a command to modify the operation of at least one of the storage node and the at least one monitoring sensor, and transmits the command to the controller for execution. In another embodiment, the storage node includes a communications module, in communication with the at least one monitoring sensor and the storm water management component, that receives from the at least one monitoring sensor the collected environmental data, and transmits the collected environmental data to the storm water management component.

The storm water management component executes on a computing device and receives, from the at least one monitoring sensor, collected environmental data. The storm water management component analyzes the received data and modifies an operation of at least one of the storage node and the at least one monitoring sensor, responsive to the analysis.

### BRIEF DESCRIPTION OF THE DRAWINGS

The foregoing and other objects, aspects, features, and advantages of the disclosure will become more apparent and better understood by referring to the following description taken in conjunction with the accompanying drawings, in which:

FIG. 1A is a block diagram depicting one embodiment of a system for monitoring, controlling, and recording performance of a storm water runoff network;

FIG. 1B-1D are block diagrams depicting embodiments of computers useful in connection with the methods and systems described herein;

FIG. 2A is a block diagram depicting another embodiment of a system for monitoring, controlling, and recording performance of a storm water runoff network;

FIG. 2B is a block diagram depicting another embodiment of a system for monitoring, controlling, and recording performance of a storm water runoff network;

FIG. 2C is a block diagram depicting an embodiment of a system for monitoring, controlling, and recording performance of a storm water runoff network including a plurality of storage nodes 210;

FIG. 3A is a flow diagram depicting an embodiment of a method for monitoring, controlling, and recording performance of a storm water runoff network; and

FIG. 3B is a flow diagram depicting an embodiment of a method for analyzing environmental data associated with a storage node and identifying a modification to the storage node.

### DETAILED DESCRIPTION

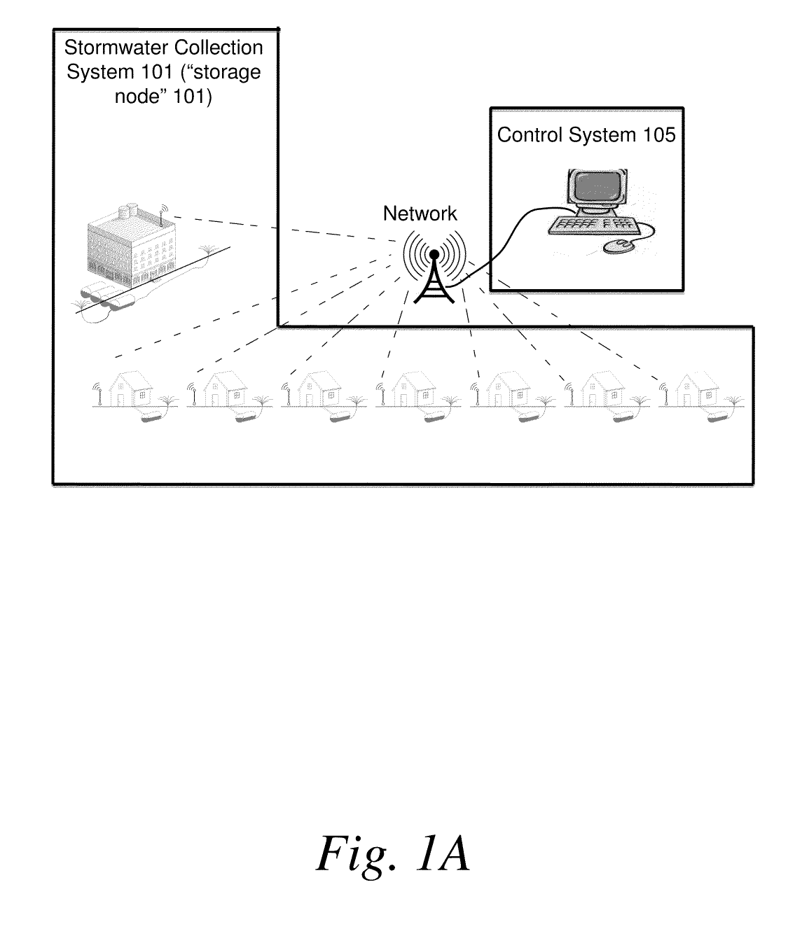

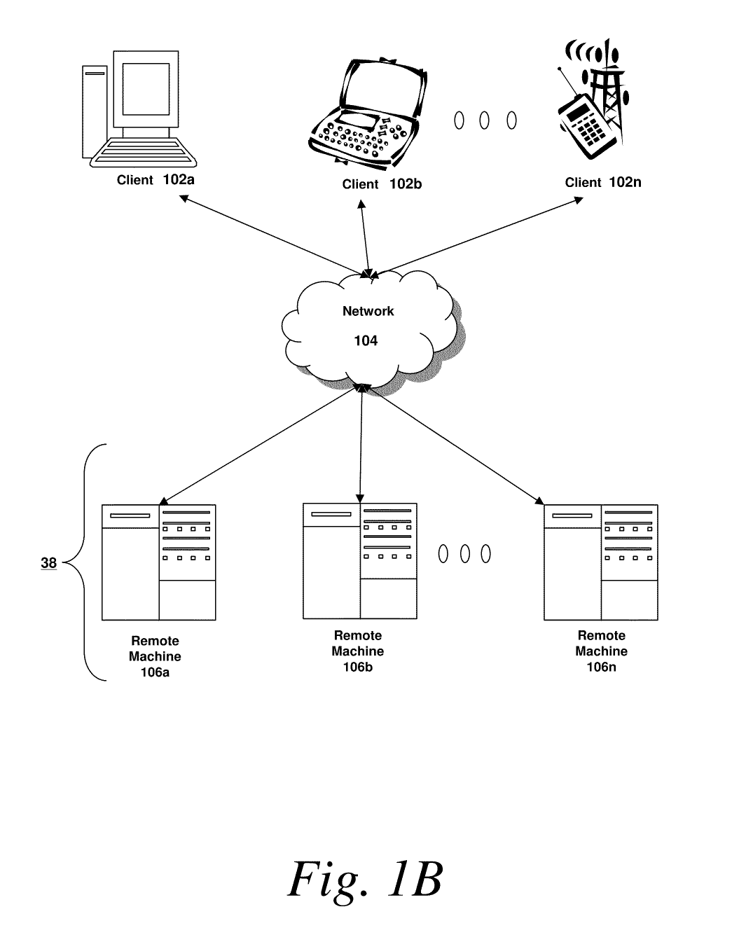

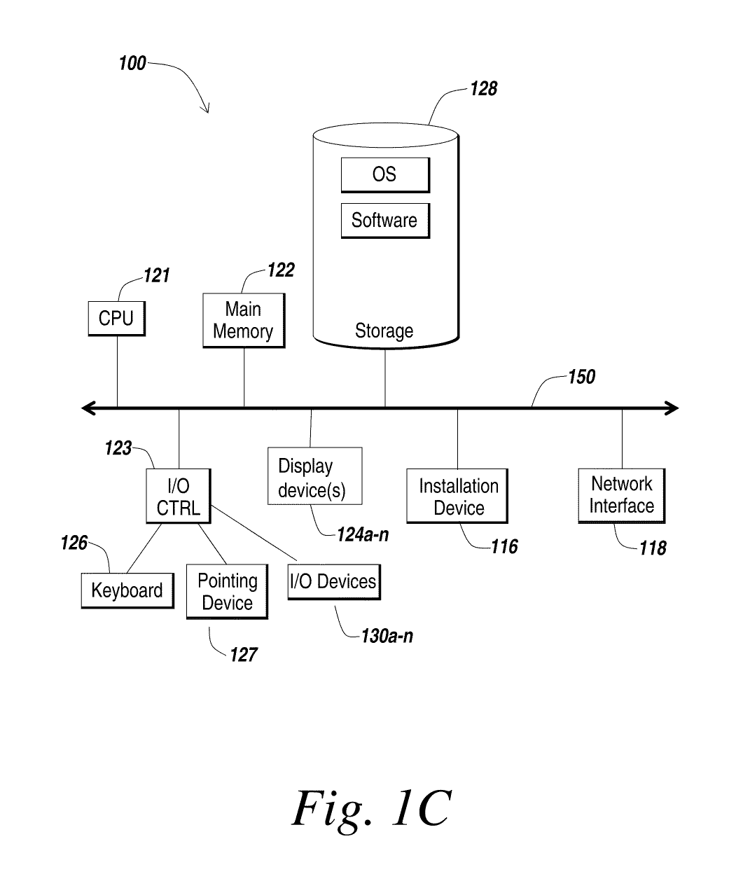

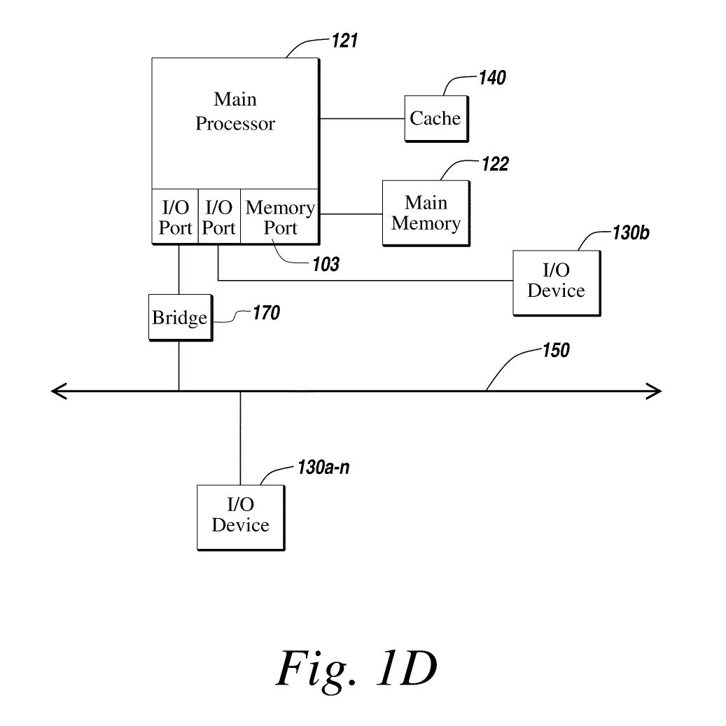

In some embodiments of the methods and systems described herein, functionality is provided for monitoring, controlling, and recording performance of a storm water runoff network. In some of these embodiments, such methods and systems minimize peak storm water runoff, maximize groundwater recharge, and maximize water reuse. Referring now to FIG. 1A, a block diagram depicts one embodiment of a system for monitoring, controlling, and recording performance of a storm water runoff network. In one embodiment, the system increases the efficiency and capacity of existing water-handling infrastructure by, for example, adding monitoring and control capabilities to distributed storm water management systems, by coordinating the performance of distributed infrastructure components, and by optimizing network performance to achieve storm water management goals.

In some embodiments, the system includes a network of interlinked storm water runoff collection systems 101. In one embodiment, a storm water runoff collection system 101 includes a tank or other collection basin to receive runoff; filters, valves, and pumps to treat and control runoff; monitoring probes to measure the status of parameters such as water level, temperature, and water quality; and data communication hardware and software. One or more such storm water runoff collection systems 101, comprise a “storm water network” in which each storm water runoff collection system 101 acts as a node on the network, and may be referred to as a storage node 101. In one embodiment, each storage node 101 is monitored and controlled using remote communications technology based on wireless internet, cellular, satellite, radio, and/or other communication systems to gather data from and send commands to the storage node 101. Data from multiple storage nodes are received, parsed and stored by a control system 105. In one embodiment, the control system 105 facilitates the capture of storm water runoff. In another embodiment, the control system 105 facilitates the release of the captured water for use during high water demand periods. In still another embodiment, the control system 105 facilitates the storage of water for future use. In yet another embodiment, the control system 105 facilitates the recharging of groundwater aquifers. Although FIG. 1A depicts only one storage node 101 and one control system 105, it is to be understood that the system may include multiple ones of any or each of those components; for example, a storm water network may include multiple storage nodes 101 and the functionality of control system 105 may be distributed across multiple computers.

Before describing methods and systems for monitoring, controlling, and recording performance of a storm water runoff network in detail, a description is provided of a network in which such methods and systems may be implemented. Referring now to FIG. 1B, an embodiment of a network environment is depicted. In brief overview, the network environment comprises one or more clients 102a-102n (also generally referred to as local machine(s) 102, client(s) 102, client node(s) 102, client machine(s) 102, client computer(s) 102, client device(s) 102, endpoint(s) 102, or endpoint node(s) 102) in communication with one or more remote machines 106a-106n (also generally referred to as server(s) 106, computing device(s) 106, or remote machine(s) 106) via one or more networks 104.

Although FIG. 1B shows a network 104 between the clients 102 and the remote machines 106, the clients 102 and the remote machines 106 may be on the same network 104. The network 104 can be a local-area network (LAN), such as a company Intranet, a metropolitan area network (MAN), or a wide area network (WAN), such as the Internet or the World Wide Web. In some embodiments, there are multiple networks 104 between the clients 102 and the remote machines 106. In one of these embodiments, a network 104′ (not shown) may be a private network and a network 104 may be a public network. In another of these embodiments, a network 104 may be a private network and a network 104′ a public network. In still another embodiment, networks 104 and 104′ may both be private networks.

The network 104 may be any type and/or form of network and may include any of the following: a point to point network, a broadcast network, a wide area network, a local area network, a telecommunications network, a data communication network, a computer network, an ATM (Asynchronous Transfer Mode) network, a SONET (Synchronous Optical Network) network, a SDH (Synchronous Digital Hierarchy) network, a wireless network and a wireline network. In some embodiments, the network 104 may comprise a wireless link, such as an infrared channel or satellite band. The topology of the network 104 may be a bus, star, or ring network topology. The network 104 may be of any such network topology as known to those ordinarily skilled in the art capable of supporting the operations described herein. The network may comprise mobile telephone networks utilizing any protocol or protocols used to communicate among mobile devices, including AMPS, TDMA, CDMA, GSM, GPRS or UMTS. In some embodiments, different types of data may be transmitted via different protocols. In other embodiments, the same types of data may be transmitted via different protocols.

In some embodiments, the system may include multiple, logically-grouped remote machines 106. In one of these embodiments, the logical group of remote machines may be referred to as a server farm 38. In another of these embodiments, the remote machines 106 may be geographically dispersed. In other embodiments, a server farm 38 may be administered as a single entity. In still other embodiments, the server farm 38 comprises a plurality of server farms 38. The remote machines 106 within each server farm 38 can be heterogeneous—one or more of the remote machines 106 can operate according to one type of operating system platform (e.g., WINDOWS NT, manufactured by Microsoft Corp. of Redmond, Wash.), while one or more of the other remote machines 106 can operate on according to another type of operating system platform (e.g., Unix or Linux).

The remote machines 106 of each server farm 38 do not need to be physically proximate to another remote machine 106 in the same server farm 38. Thus, the group of remote machines 106 logically grouped as a server farm 38 may be interconnected using a wide-area network (WAN) connection or a metropolitan-area network (MAN) connection. For example, a server farm 38 may include remote machines 106 physically located in different continents or different regions of a continent, country, state, city, campus, or room. Data transmission speeds between remote machines 106 in the server farm 38 can be increased if the remote machines 106 are connected using a local-area network (LAN) connection or some form of direct connection.

The client 102 and remote machine 106 may be deployed as and/or executed on any type and form of computing device, such as a computer, network device or appliance capable of communicating on any type and form of network and performing the operations described herein. FIGS. 1C and 1D depict block diagrams of a computing device 100 useful for practicing an embodiment of the client 102 or a remote machine 106. As shown in FIGS. 1C and 1D, each computing device 100 includes a central processing unit 121, and a main memory unit 122. As shown in FIG. 1C, a computing device 100 may include a storage device 128, an installation device 116, a network interface 118, an I/O controller 123, display devices 124a-n, a keyboard 126 and a pointing device 127, such as a mouse. The storage device 128 may include, without limitation, an operating system and software. As shown in FIG. 1D, each computing device 100 may also include additional optional elements, such as a memory port 103, a bridge 170, one or more input/output devices 130a-130n (generally referred to using reference numeral 130), and a cache memory 140 in communication with the central processing unit 121.

The central processing unit 121 is any logic circuitry that responds to and processes instructions fetched from the main memory unit 122. In many embodiments, the central processing unit 121 is provided by a microprocessor unit, such as: those manufactured by Intel Corporation of Mountain View, Calif.; those manufactured by Motorola Corporation of Schaumburg, Ill.; those manufactured by Transmeta Corporation of Santa Clara, Calif.; the RS/6000 processor, those manufactured by International Business Machines of White Plains, N.Y.; or those manufactured by Advanced Micro Devices of Sunnyvale, Calif. The computing device 100 may be based on any of these processors, or any other processor capable of operating as described herein.

Main memory unit 122 may be one or more memory chips capable of storing data and allowing any storage location to be directly accessed by the microprocessor 121, such as Static random access memory (SRAM), Burst SRAM or SynchBurst SRAM (BSRAM), Dynamic random access memory (DRAM), Fast Page Mode DRAM (FPM DRAM), Enhanced DRAM (EDRAM), Extended Data Output RAM (EDO RAM), Extended Data Output DRAM (EDO DRAM), Burst Extended Data Output DRAM (BEDO DRAM), Enhanced DRAM (EDRAM), synchronous DRAM (SDRAM), JEDEC SRAM, PC100 SDRAM, Double Data Rate SDRAM (DDR SDRAM), Enhanced SDRAM (ESDRAM), SyncLink DRAM (SLDRAM), Direct Rambus DRAM (DRDRAM), or Ferroelectric RAM (FRAM). The main memory 122 may be based on any of the above described memory chips, or any other available memory chips capable of operating as described herein. In the embodiment shown in FIG. 1C, the processor 121 communicates with main memory 122 via a system bus 150 (described in more detail below). FIG. 1D depicts an embodiment of a computing device 100 in which the processor communicates directly with main memory 122 via a memory port 103. For example, in FIG. 1D the main memory 122 may be DRDRAM.

FIG. 1D depicts an embodiment in which the main processor 121 communicates directly with cache memory 140 via a secondary bus, sometimes referred to as a backside bus. In other embodiments, the main processor 121 communicates with cache memory 140 using the system bus 150. Cache memory 140 typically has a faster response time than main memory 122 and is typically provided by SRAM, BSRAM, or EDRAM. In the embodiment shown in FIG. 1D, the processor 121 communicates with various I/O devices 130 via a local system bus 150. Various buses may be used to connect the central processing unit 121 to any of the I/O devices 130, including a VESA VL bus, an ISA bus, an EISA bus, a MicroChannel Architecture (MCA) bus, a PCI bus, a PCI-X bus, a PCI-Express bus, or a NuBus. For embodiments in which the I/O device is a video display 124, the processor 121 may use an Advanced Graphics Port (AGP) to communicate with the display 124. FIG. 1C depicts an embodiment of a computer 100 in which the main processor 121 communicates directly with I/O device 130b, for example, via HYPERTRANSPORT, RAPIDIO, or INFINIBAND communications technology. FIG. 1D also depicts an embodiment in which local busses and direct communication are mixed: the processor 121 communicates with I/O device 130a using a local interconnect bus while communicating with I/O device 130b directly.

A wide variety of I/O devices 130a-130n may be present in the computing device 100. Input devices include keyboards, mice, trackpads, trackballs, microphones, scanners, cameras and drawing tablets. Output devices include video displays, speakers, inkjet printers, laser printers, and dye-sublimation printers. The I/O devices may be controlled by an I/O controller 123 as shown in FIG. 1C. The I/O controller may control one or more I/O devices such as a keyboard 126 and a pointing device 127, e.g., a mouse or optical pen. Furthermore, an I/O device may also provide storage and/or an installation medium 116 for the computing device 100. In still other embodiments, the computing device 100 may provide USB connections (not shown) to receive handheld USB storage devices such as the USB Flash Drive line of devices manufactured by Twintech Industry, Inc. of Los Alamitos, Calif.

Referring again to FIG. 1C, the computing device 100 may support any suitable installation device 116, such as a floppy disk drive for receiving floppy disks such as 3.5-inch, 5.25-inch disks or ZIP disks, a CD-ROM drive, a CD-R/RW drive, a DVD-ROM drive, tape drives of various formats, USB device, hard-drive or any other device suitable for installing software and programs. The computing device 100 may further comprise a storage device, such as one or more hard disk drives or redundant arrays of independent disks, for storing an operating system and other related software, and for storing application software programs. Optionally, any of the installation devices 116 could also be used as the storage device. Additionally, the operating system and the software can be run from a bootable medium, for example, a bootable CD, such as KNOPPIX, a bootable CD for GNU/Linux that is available as a GNU/Linux distribution from knoppix.net.

Furthermore, the computing device 100 may include a network interface 118 to interface to the network 104 through a variety of connections including, but not limited to, standard telephone lines, LAN or WAN links (e.g., 802.11, T1, T3, 56kb, X.25, SNA, DECNET), broadband connections (e.g., ISDN, Frame Relay, ATM, Gigabit Ethernet, Ethernet-over-SONET), wireless connections, or some combination of any or all of the above. Connections can be established using a variety of communication protocols (e.g., TCP/IP, IPX, SPX, NetBIOS, Ethernet, ARCNET, SONET, SDH, Fiber Distributed Data Interface (FDDI), RS232, IEEE 802.11, IEEE 802.11a, IEEE 802.11b, IEEE 802.11g, IEEE 802.11n, CDMA, GSM, WiMax and direct asynchronous connections). In one embodiment, the computing device 100 communicates with other computing devices 100′ via any type and/or form of gateway or tunneling protocol such as Secure Socket Layer (SSL) or Transport Layer Security (TLS). The network interface 118 may comprise a built-in network adapter, network interface card, PCMCIA network card, card bus network adapter, wireless network adapter, USB network adapter, modem or any other device suitable for interfacing the computing device 100 to any type of network capable of communication and performing the operations described herein.

In some embodiments, a computer 100 connects to a second computer 100′ on a network using any one of a number of well-known protocols from the GSM or CDMA families, such as W-CDMA. These protocols support commercial wireless communication services and W-CDMA, in particular is the underlying protocol supporting i-Mode and mMode services, offered by NTT DoCoMo.

In some embodiments, the computing device 100 may comprise or be connected to multiple display devices 124a-124n, which each may be of the same or different type and/or form. As such, any of the I/O devices 130a-130n and/or the I/O controller 123 may comprise any type and/or form of suitable hardware, software, or combination of hardware and software to support, enable or provide for the connection and use of multiple display devices 124a-124n by the computing device 100. In some embodiments, any portion of the operating system of the computing device 100 may be configured for using multiple displays 124a-124n. One ordinarily skilled in the art will recognize and appreciate the various ways and embodiments that a computing device 100 may be configured to have multiple display devices 124a-124n.

In further embodiments, an I/O device 130 may be a bridge between the system bus 150 and an external communication bus, such as a USB bus, an Apple Desktop Bus, an RS-232 serial connection, a SCSI bus, a FireWire bus, a FireWire 800 bus, an Ethernet bus, an AppleTalk bus, a Gigabit Ethernet bus, an Asynchronous Transfer Mode bus, a HIPPI bus, a Super HIPPI bus, a SerialPlus bus, a SCI/LAMP bus, a FibreChannel bus, or a Serial Attached small computer system interface bus.

A computing device 100 of the sort depicted in FIGS. 1C and 1D typically operates under the control of operating systems, which control scheduling of tasks and access to system resources. The computing device 100 can be running any operating system such as any of the versions of the MICROSOFT WINDOWS operating systems, the different releases of the Unix and Linux operating systems, any version of the MAC OS for Macintosh computers, any embedded operating system, any real-time operating system, any open source operating system, any proprietary operating system, any operating systems for mobile computing devices, or any other operating system capable of running on the computing device and performing the operations described herein. Typical operating systems include, but are not limited to: WINDOWS 3.x, WINDOWS 95, WINDOWS 98, WINDOWS 2000, WINDOWS NT 3.51, WINDOWS NT 4.0, WINDOWS CE, WINDOWS XP, WINDOWS 7 and WINDOWS VISTA, all of which are manufactured by Microsoft Corporation of Redmond, Wash.; MAC OS, manufactured by Apple Inc., of Cupertino, Calif.; OS/2, manufactured by International Business Machines of Armonk, N.Y.; and Linux, a freely-available operating system distributed by Caldera Corp. of Salt Lake City, Utah, or any type and/or form of a Unix operating system, among others.

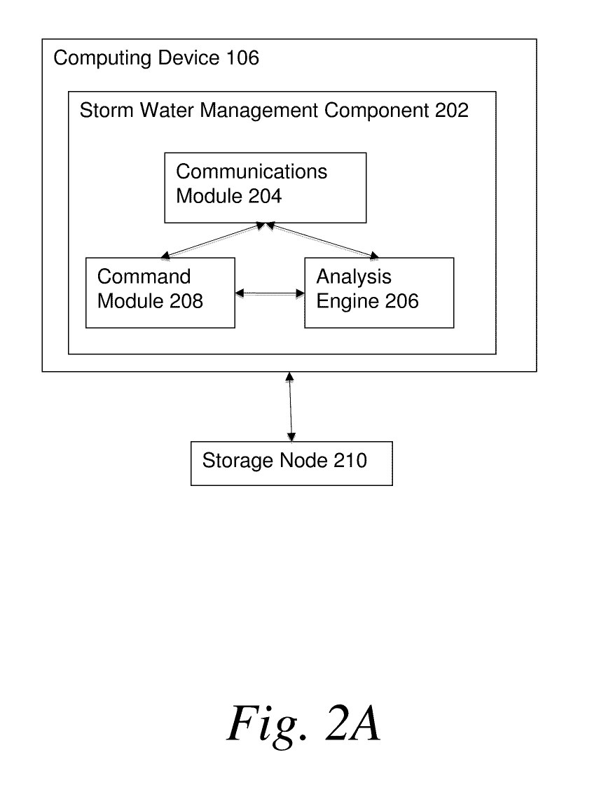

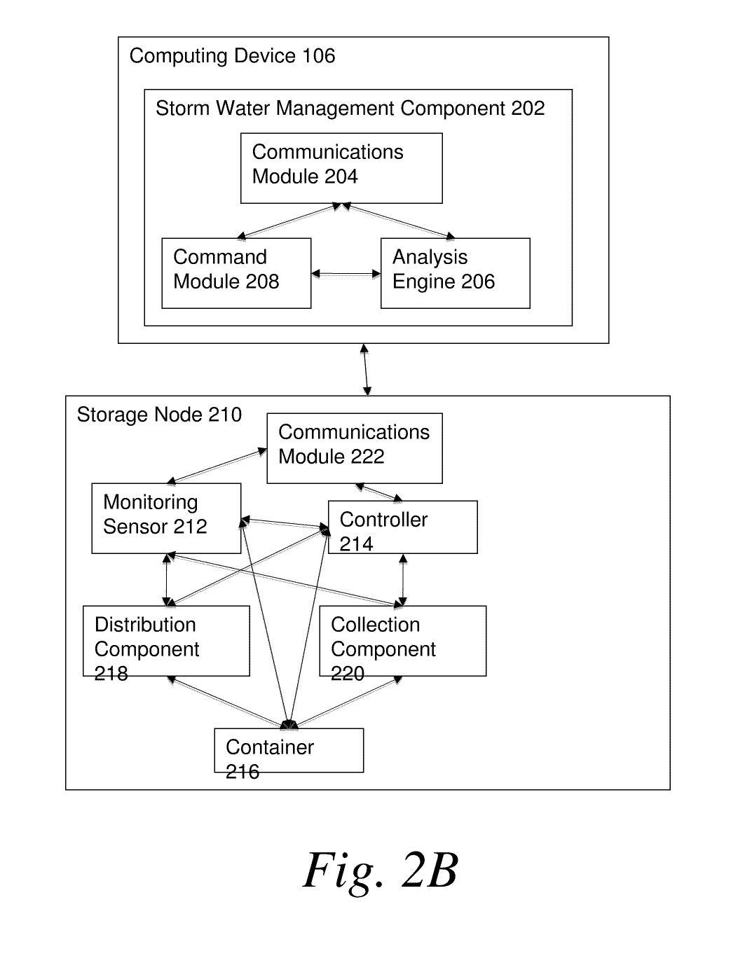

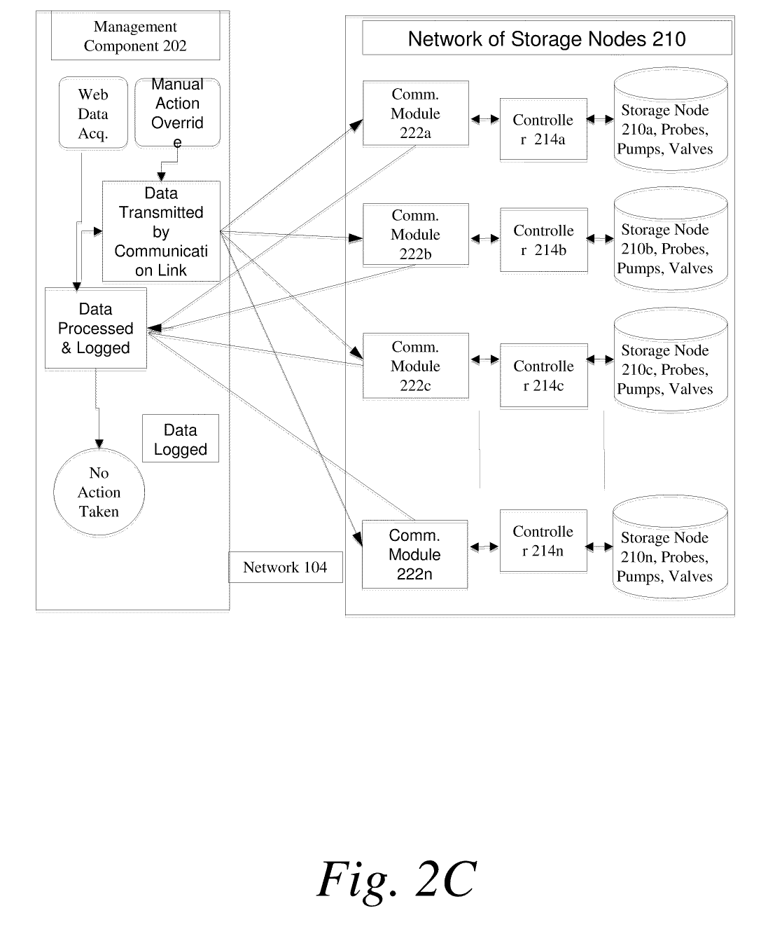

Referring now to FIG. 2A, a block diagram depicts one embodiment of a system for monitoring, controlling, and recording performance of a storm water runoff network. In brief overview, the system includes a storm water management component 202, a communications module 204, an analysis engine 206, a command module 208, and a storage node 210. In some embodiments, captured runoff reduces the burden on storm-drainage systems and can be pumped into the drainage system at non-peak periods or can be used internally, used to recharge groundwater or used to supply water for reuse, e.g., lawn irrigation during dry periods. In one embodiment, analysis of environmental conditions by the storm water management component 202 and real-time customization of storage node operations enables the system to operate more efficiently.

In one embodiment, the storm water management component 202 receives data and status information (e.g., water level, temperature, water quality, valve positions, pump status) from at least one storage node 210. In another embodiment, the storm water management component 202 receives general weather conditions and forecasts, as well as monitored information from the storage node 210 (e.g., data collected by at least one monitoring sensor). This data provides short- and intermediate-term utilization predictions, both in terms of runoff burden (during wet periods) and water usage (e.g., for irrigation during dry periods). The storm water management component 202 also receives status information from all storage nodes in a plurality of storage nodes 210; these data are analyzed with management optimization algorithms to determine what control actions should be taken, depending on the goals of the system. The storm water management component 202 sends commands to the storage node 210 to activate/deactivate pumps and valves or to perform other electro-mechanical actions. The storm water management component 202 also performs routine diagnostic analyses to ensure proper operation of mechanical and electrical equipment (e.g., pumps).

The communications module 204 executes on the computing device 106. The communications module 204 receives environmental data associated with a storage node 210. Transmission of data to, and receipt of commands from, the storm water management component 202 is facilitated for a storage node 210 by a communication module 204.

The analysis engine 206 executes on the computing device 106. The analysis engine 206 analyzes the received environmental data and identifies a setting for the storage node 210. In some embodiments, the analysis engine 206 analyzes environmental data received from a plurality of storage nodes and identifies the setting for the storage node 210 responsive to the analysis of the data received from the plurality of storage nodes. In other embodiments, data is continually gathered and transmitted to the storm water management component 202 for analysis.

The command module 208 executes on the computing device 106. The command module 208 directs the execution of a command to set the storage node 210 to the identified setting responsive to the analysis. In one embodiment, the command module 208 generates a command to be executed on the storage node 210. In another embodiment, the command module 208 determines that manual intervention is required and transmits an indication of the determination to a user, such as an administrator of the storm water management component 202.

In one embodiment, the communications module 204, the analysis engine 206, and the command module 208 form the storm water management component 202. In another embodiment, a communications module 204, an analysis engine 206, a command module 208, and the storm water management component 202 execute on a computing device 106, which may be provided as a computing device as described above in connection with FIGS. 1B-1D.

Referring now to FIG. 2A, and in greater detail, the storm water management component 202 includes the communications module 204, the analysis engine 206, and the command module 208. The communications module 204 receives environmental data associated with the storage node 210. In one embodiment, the communications module 204 includes a transmitter, sending to the storage node 201, the command generated by the command module 208 for execution. In another embodiment, the communications module 204 includes a receiver receiving, from a second computing device 106b (not shown), environmental data associated with the storage node.

The analysis engine 206 analyzes the received environmental data and identifies a setting for the storage node 210. In one embodiment, the analysis engine 206 accesses a database storing the received environmental data. In another embodiment, the communications module 204 transmits the received environmental data to the analysis engine. In still another embodiment, the analysis engine 206 executes a computer program to evaluate the environmental data and identify the setting for the storage node 210. In another embodiment, the analysis engine 206 performs time series processing (e.g., calculation of pumping volumes over time), evaluates thresholds reached (e.g., a container 216 is empty), performs quantitative data calculations (e.g., compare status of multiple storage nodes 210), and calculates optimal settings for the storage node 210 (e.g., calculate an optimal pumping rate).

The command module 208 directs the execution of a command to set the storage node 210 to the identified setting responsive to the analysis. In one embodiment, the command module 208 generates a command for execution by a component in the storage node 210.

In some embodiments, the command module 208 sends electronic commands to a controller 214 (which may also be referred to as a programmable logic controller (PLC) or a programmable logic relay (PLR)) that, in turn relays a signal to, or changes an electrical setting on, a component (including, for example, pumps, valves, gates, and monitoring probe). In other embodiments, the controller 214 is integrated with a data logging and storage device, such as, for example, those provided by Campbell Scientific, Inc., of Logan, Utah, USA. In still other embodiments, the controller 214 is a computer of the type described above in connection with FIGS. 1B-1D. In further embodiments, the command module 208 selects a setting for modification from a plurality of component settings, such as pump on/off or gate or valve setting, that it communicates to the controller 214. In one embodiment, the command module 208 selects a setting based upon a determination made by the analysis engine 206.

In one embodiment, the system includes a reporting component (not shown) generating a report. In another embodiment, a report is based on data generated by the storage node 210 and received by the storm water management component 202. In still another embodiment, a report is generated that satisfies an environmental regulatory requirement. In some embodiments, storm water permits, issued by the US Environmental Protection Agency or by state environmental agencies, require permit holders to provide such a report on a monthly, quarterly, or annual basis. In other embodiments, the report includes data describing flow rates, pollutant concentrations, water volumes stored or pumped, and environmental conditions.

Referring now to FIG. 2B, a block diagram depicts another embodiment of a system for monitoring, controlling, and recording performance of a storm water runoff network. In brief overview, the system includes a storm water management component 202, a storage node 210, at least one monitoring sensor 212, and a controller 214. The storage node 210 stores runoff in a container 216. The at least one monitoring sensor 212 collects environmental data associated with the storage node 210. The controller 214 executes a command to operate the storage node 210. The storm water management component 202 receives, from the at least one monitoring sensor 212, collected environmental data, analyzes the received data, and modifies an operation of at least one of the storage node 210 and the at least one monitoring sensor, responsive to the analysis. In some embodiments, the system includes a first computing device 106 which provides some or all of the functionality of the storm water management component 202 and a second computing device 102 which provides some or all of the functionality of the storage node 210. In other embodiments, the system includes additional computing devices 102, such as laptops or mobile computing devices, operable to connect to the storage node 210 and which may include functionality for executing commands at the storage node 210.

Referring now to FIG. 2B, and in greater detail, the storage node 210 stores runoff in a container 216. In some embodiments, the storage node 210 includes a collection component 220 that collects storm water runoff and stores the storm water runoff in the container 216. The storage node 210 conducts water from the container 216 for use. In one embodiment, the storage node 210 discharges water from the container 216. In some embodiments, the storage node 210 includes a distribution component 218 for conducting water from the container 216. In other embodiments, the collection component 220 and the distribution component 218 are provided as any of the standard components in the use of storm water runoff management known in the art. Examples of containers 216 include on-site earthen detention basins, above ground tanks such as the Porta Tank manufactured by Environetics, Inc., of Lockport, Ill., USA, or underground tanks such as the Super-Flo manufactured by Hydro International plc of Clevedon, UK. Examples of distribution components 218 include many brands of pumps with examples including OTS Self-Priming manufactured by The Gorman-Rupp International Company, of Mansfield, Ohio, USA, and the Unilift line of pumps manufactured by Grundfos Holding A/S of Bjerringbro, Denmark.

In one embodiment, the storage node 210 includes at least one computing device 102; for example, the storage node 210 may include a computing device of the type described above in connection with FIGS. 1B-1D. In another embodiment, a computing device 102 provides some or all of the functionality provided by the storage node 210; for example, the computing device 102 may provide the communications module 222. In still another embodiment, the storage node 210 includes a data-logging component. For example, and without limitation, the storage node 210 includes a data-logger of the type manufactured by Campbell Scientific, Inc., of Logan, Utah, USA.

In one embodiment, the container 216 is a tank, vessel, basin, retention basin, collection basin, or other container for collecting water. In another embodiment, the storage node 210 includes a valve. In another embodiment, the storage node 210 includes a pump. In another embodiment, a distribution component 218 includes a pipe for diverting water into or out of a container 216. In still another embodiment, the storage node 210 includes a plurality of monitoring sensors 212.

In one embodiment, the at least one monitoring sensor 212 is an internal monitoring probe within the container 216 and measures the status of parameters such as water level, temperature, and water quality. In another embodiment, the at least one monitoring sensor 212 is a sensor within a pump or a valve that reports operational parameters and is operatively associated with an actuator that permits remote operation. In some embodiments, the controller 214 polls the at least one monitoring sensor 212 to retrieve collected data.

In one embodiment, the at least one monitoring sensor 212 detects conditions associated with water in the container 216. In another embodiment, the at least one monitoring sensor 212 identifies a level of water in the container 216. In still another embodiment, the at least one monitoring sensor 212 identifies a level of quality of water in the container 216. In another embodiment, the at least one monitoring sensor 212 detects a level of water in the container 216. In yet another embodiment, the at least one monitoring sensor 212 a water quality characteristic. In some embodiments, temperature is a water quality characteristic. In other embodiments, chemical concentrations (e.g., levels of phosphorous, chloride, iron or other chemicals) are water quality characteristics. In still other embodiments, an amount of total dissolved solids (e.g., levels of minerals dissolved in the water) are water quality characteristics.

In one embodiment, the at least one monitoring sensor 212 identifies a pumping rate of the storage node 210. In another embodiment, the at least one monitoring sensor 212 identifies a pumping rate of a component within the storage node 210. In still another embodiment, the at least one monitoring sensor 212 identifies a valve position of the storage node. In still another embodiment, the at least one monitoring sensor 212 identifies a position of a valve in a component within the storage node 210. In yet another embodiment, the at least one monitoring sensor 212 collects operational data associated with the storage node 210, such as the make and model of a component within the storage node 210, hours of operation since last maintenance, range of typical operating performance metrics.

In one embodiment, the at least one monitoring sensor 212 identifies an electrical power status of the storage node 210. In another embodiment, the at least one monitoring sensor 212 identifies a battery charge status of the storage node 210. In still another embodiment, the at least one monitoring sensor 212 identifies a battery voltage for a battery at the storage node 210. In another embodiment, the at least one monitoring sensor 212 identifies line voltage at the storage node 210. In yet another embodiment, the at least one monitoring sensor 212 identifies an Ethernet connection status for a computing device 102 at the storage node 210.

In one embodiment, the at least one monitoring sensor 212 detects conditions associated with soil at a storage node 210′s physical location; for example, the at least one monitoring sensor 212 may monitor soil moisture levels. In another embodiment, the at least one monitoring sensor 212 detects precipitation accumulation. In still another embodiment, the at least one monitoring sensor 212 detects air temperature. In yet another embodiment, the at least one monitoring sensor 212 detects stream or pond water levels.

In one embodiment, a component within a storage node 210 includes the monitoring sensor 212; for example, a distribution component 218, collection component 220, or container 216 may be purchased from a manufacturer with the monitoring sensor 212 integrated into the component or container. In another embodiment, a monitoring sensor 212 is attached to a component within the storage node 210 after the component has been acquired from a manufacturer (e.g., a node administrator retrofits the component with a monitoring sensor 212 after purchase). In some embodiments, monitoring probes can include, for example, the Hydra Probe Soil Moisture Probe or the SDX Pressure Sensor, manufactured by Stevens Water Monitoring Systems, Inc., of Portland, Oreg., USA.

In another embodiment, the communications module 222 is in communication with the at least one monitoring sensor 212 and with the storm water management component 202; the communications module 222 receives, from the least one monitoring sensor, the collected environmental data and transmits the collected environmental data to the storm water management component 202.

The storm water management component 202 may be a storm water management component 202 as described above in connection with FIG. 2A. In one embodiment, the storm water management component 202 includes the communications module 204. In another embodiment, the communications module 204 receives operational data from the storage node 210.

In some embodiments, the storm water management component 202 displays a user interface with which a user, such as an administrator of the storage node 210 and/or the storm water management component 202 may execute commands manually and review received data, generated commands, alerts, charts (e.g., chart of total storage over time), diagrammatic displays (e.g., display of pump status at all storage nodes 210 in a plurality of storage nodes).

In one embodiment, the storm water management component 202 is in communication with a second computing device 106b (not shown) from which the storm water management component 202 receives additional environmental data associated with the storage node 210. In another embodiment, the storm water management component 202 receives operational data from the second computing device 106b. In still another embodiment, the storm water management component 202 receives data from the second computing device 106b over a public network 104 (e.g., the Internet), the data including, by way of example, forecast precipitation, precipitation accumulation, air temperature, and streamflow data, received from sources such as the National Weather Services, and weather and soil data from sources such as the United States Department of Agriculture (USDA). For example, and without limitation, data received from the second computing device 106b may include forecasts for a pre-defined period at a specific location (e.g., 5-day forecasts for a physical location of the storage node 210), data from the National Oceanographic and Atmospheric Administration (NOAA), and meteorological data from national and international meteorological institutes (e.g., data formatted according to a Gridded Binary standard). In yet another embodiment, the storm water management component 202 provides this data to the analysis engine 206 for analysis.

In one embodiment, the command module 208 generates a command to modify the operation of a component, such as the storage node 210 or the at least one monitoring sensor 212, which the communications module 204 transmits to the controller 214 for execution. In this way, the storm water management component 202 modifies the operation of the storage node and/or the at least one monitoring sensor 212. In some embodiments, the storm water management component 202 generates an alert to a user; for example, the storm water management component 202 may generate and send an emergency notification to an administrator via phone or email.

In one embodiment, the storage node 210 includes a communications module 222, in communication with the controller 214 and the storm water management component 202 and receiving from the storm water management component 202, a command to modify the operation of at least one of the storage node and the at least one monitoring sensor; the communications module 222 transmits the command to the controller 214 for execution.

In some embodiments, the controller 214 is operatively coupled both to the communications module 222 and to a plurality of components within the storage node 210. In one embodiment, the controller 214 includes functionality for collecting water in the container 216. In another embodiment, the controller 214 executes a command resulting in water collection by the collection component 220. In still another embodiment, the controller 214 activates a mechanism in the collection component 220 resulting in collection of water in the container 216. In yet another embodiment, the controller 214 sends a signal or closes a relay switch that energizes an electrically driven actuator that moves a valve or hydraulic gate into the desired position (open/closed).

In one embodiment, the controller 214 includes functionality for distributing water from the container 216. In another embodiment, the controller 214 executes a command resulting in distribution of water from the container 216. In still another embodiment, the controller 214 activates a mechanism in the distribution component 218 resulting in distribution of water from the container 216. In some embodiments, the controller 214 sends a signal or closes a relay switch that energizes an electrically driven pump. In other embodiments, water from the container 216 can be distributed for example to an irrigation system, a dry well, an indoor greywater system, a washing system, a cooling system or into a storm water drainage pipe.

Referring now to FIG. 2C, a block diagram depicts one embodiment of a system for monitoring, controlling, and recording performance of a storm water runoff network including a plurality of storage nodes 210. As depicted in FIG. 2C, in some embodiments, the storm water management component 202 receives data from, and transmits commands to, multiple storage nodes 210.

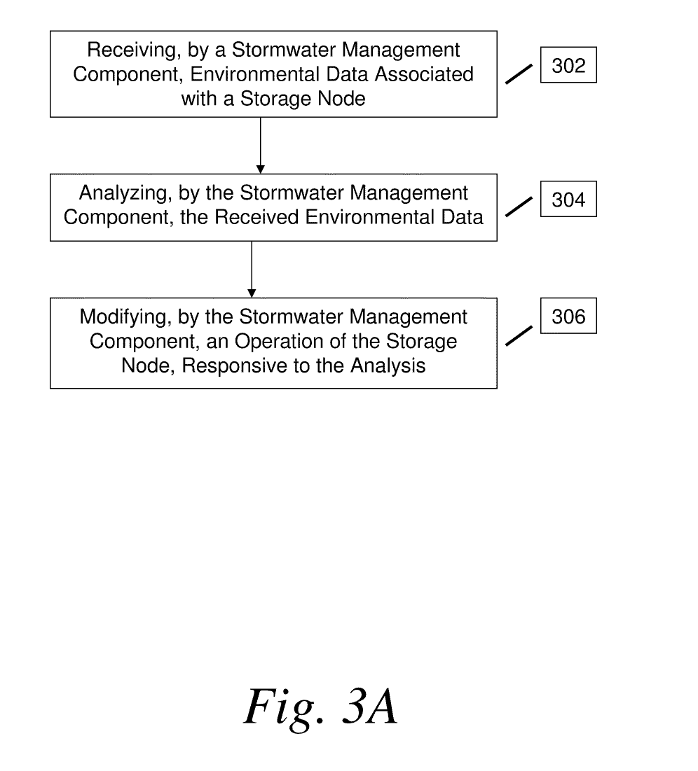

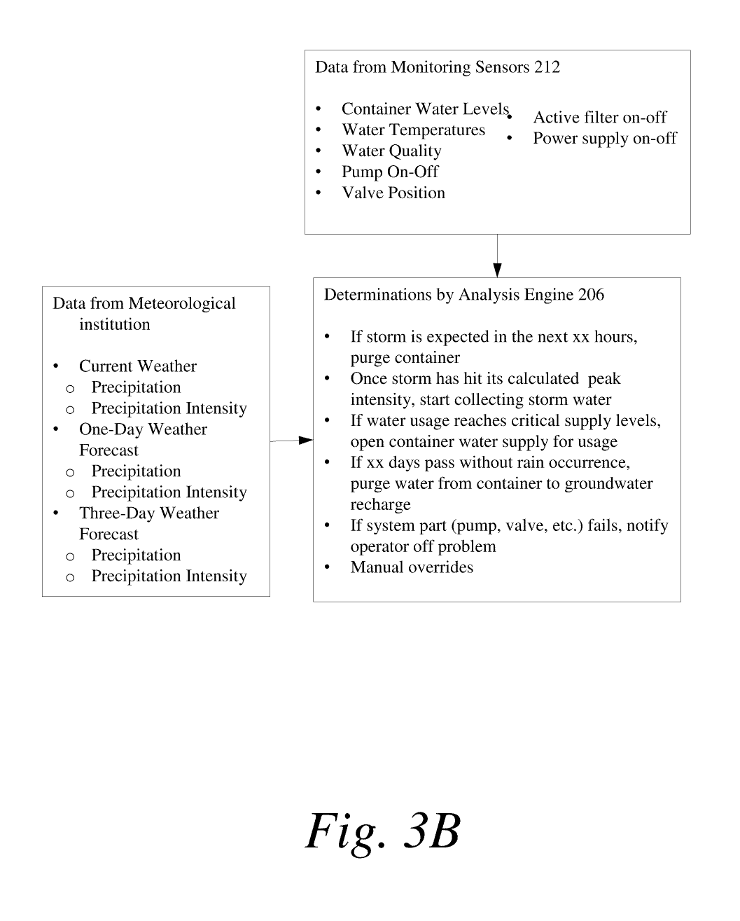

Referring now to FIG. 3A, a flow diagram depicts one embodiment of a method for monitoring, controlling, and recording performance of a storm water runoff network. In brief overview, the method includes receiving, by a storm water management component, environmental data associated with a storage node (302). The method includes analyzing, by the storm water management component, the received environmental data (304). The method includes modifying, by the storm water management component, an operation of the storage node, responsive to the analysis (306).

The storm water management component 202 receives environmental data associated with a storage node (302). In some embodiments, the storm water management component 202 requests the environmental data from the storage node 210. In one embodiment, the storm water management component 202 receives the environmental data from a monitoring sensor. In some embodiments, the at least one monitoring sensor 212 records data at periodic intervals. In other embodiments, the at least one monitoring sensor 212 transmits the recorded data to the communications module 222 at periodic intervals. In still other embodiments, the communications module 222 requests the data from the at least one monitoring sensor 212.

In another embodiment, the storm water management component 202 receives data that follows a set protocol and data standard. In still another embodiment, the storm water management component 202 receives data transmitted according to a communications standard (e.g., SD-12). In still another embodiment, the storm water management component 202 stores the data in a storage element of the computing device 106. In still another embodiment, the storm water management component 202 distributes the data to other storage nodes 210b.

In one embodiment, the storm water management component 202 receives the data from a second computing device 106b. In another embodiment, the storm water management component 202 periodically downloads environmental data from a second computing device 106. In still another embodiment, the storm water management component 202 stores the received data for later use.

In some embodiments, the storm water management component 202 formats the received data. For example, and without limitation, the communications module 204 of the storm water management component 202 may receive the data, identify portions of the received data to be analyzed by the analysis engine 206 and forward the identified portions of the received data to the analysis engine 206. In other embodiments, the communications module 204 receives the data and transmits all of the received data to the analysis engine 206 without modification.

The storm water management component 202 analyzes the received environmental data (304). In one embodiment, the analysis engine 206 receives the environmental data. In another embodiment, the analysis engine 206 calculates additional data from the received environmental data. For example, and without limitation, from readings of container levels, valve positions, and pump speeds, the analysis engine 206 may calculate a water volume in the container 216, an amount of water captured in the container 216, a total volume of water captured during a storm, a volume of water recharged in the container 216, a volume of water reused in the container 216, pump operating time, and a volume of water filtered.

Referring ahead to FIG. 3B, a flow diagram depicts an embodiment of a method for analyzing environmental data associated with a storage node and identifying a modification to the storage node. In one embodiment, the analysis engine 206 analyzes the received environmental data. In another embodiment, the analysis engine 206 identifies a recommended modification to the operation of the storage node 210 and the command module 208 generates the command the storage node 210 needs to execute in order to implement the identified modification.

In one embodiment, the analysis engine 206 receives data from the at least one monitoring sensor 212 including, without limitation, tank water levels, water temperatures, water quality, pump on-off, valve position, active filter on-off, and power supply on-off. In another embodiment, the analysis engine 206 receives data from a meteorological institute including, without limitation, current weather and various forecasts. Based upon an analysis of these data, the analysis engine 206 generates determinations that the command module 208 uses to generate commands for execution at the storage node 210.

For example, the analysis engine 206 may analyze received environmental data that includes a precipitation forecast and determine that the storage node 210 should be modified so that the communications module 222 polls the at least one monitoring sensor 212 more frequently than the current polling rate specifies; the command module 208 may generate a command to the storage node 210 to modify the polling rate so that the at least one monitoring sensor 212 is polled more frequently. In one embodiment, and as another example, the analysis engine 206 receives environmental data indicating that precipitation is imminent and determines that a position of a valve at the storage node 210 should be adjusted (e.g., so that the container 216 which the valve controls is prepared to collect additional runoff); the command module 208 generates the command to modify the position of the valve based on the determination by the analysis engine 206. In still another embodiment, and by way of further example, the analysis engine 206 may analyze data including a forecast for dry weather at a storage node 210 and determine that the storage node 210 needs to discharge water for irrigation or other purposes; the command module 208 receives the determination and generates the command to discharge the water. In some embodiments, intermediate-term forecasts of wet conditions may prompt discharge from a container 216 into an irrigation system even if irrigation is not called for if the analysis engine 206 determines that it is preferable to increase available storage capacity at the container 216 so that there is sufficient capacity to receive the forecast runoff. In other embodiments, if the analysis engine 206 receives environmental data and determines that a level of water quality is below a threshold, the analysis engine 206 may direct the command module 208 to generate a command closing a valve and another command recirculating the water in the container 216 through a filter.

Referring back to FIG. 3A, and in one embodiment, the storm water management component 202 receives operational data associated with the storage node 210; for example, a monitoring sensor associated with the storage node 210 may collect the operational data and transmit the operational data to the storm water management component 202. In another embodiment, the analysis engine 206 analyzes the received environmental data and the received operational data.

In one embodiment, the analysis engine 206 determines an optimal performance of a storage node 210 by analyzing received environmental data from one or more storage nodes 210 and determining how to best manage current and forecasted storm water flows at a particular storage node 210; for example, the analysis engine 206 may apply an optimization algorithm to make the determination. In another embodiment, the analysis engine 206 optimizes for a management goal including, without limitation, minimizing peak runoff rate, maximizing reuse water, maximizing groundwater recharge, and minimizing pollutant load. In still another embodiment, by way of example, to determine the optimal control parameters and achieve these goals, the optimizations are numerically expressed with objective functions and inequality constraints. Applied at the level of a single runoff collection system the objective function may depend on one or more variables including but not limited to soil moisture, current precipitation rate, forecasted precipitation rates, water level, and pumping rate; the inequality constraints may include, by way of example, maximum pumping rate, and tank volume. With the inputs and given functions and constraints, the network and specific node optimizations are determined, which the analysis engine 206 translates into specific actions for each storage node 210.

The storm water management component 202 modifies an operation of the storage node, responsive to the analysis (306). In one embodiment, the storm water management component 202 modifies a state of a valve in the storage node, responsive to the analysis. In another embodiment, the storm water management component 202 modifies a state of a pump in the storage node, responsive to the analysis. In still another embodiment, the storm water management component 202 modifies a state of a gate in the storage node, responsive to the analysis.

By way of example, and without limitation, commands include commands to open or close valves, turn pumps on or off, activate filters, commence data transmissions, commence data collection, turn power supplies on or off, generate reports, identify system failures, initiate purge of a container 216, initiate stormwater capture at a storage node 210, stop stormwater capture at a storage node 210, release water from a container 216 for building usage (e.g., when the storage node 210 is tied into a building water supply), collect data, calculate data (e.g., use collected data to calculate storm likelihood), and record data.

In one embodiment, the command module 208 generates a command modifying the operation of the storage node 210. In another embodiment, the storm water management component 202 transmits the command to the communications module 222. In still another embodiment, the storm water management component 202 transmits the commands to a human operator; for example, the storm water management component 202 may email a copy of a command sent to the storage node 210 to a human operator for quality control. In another embodiment, the storm water management component 202 transmits the command when a user triggers an event. In yet another embodiment, the storm water management component 202 transmits the command at periodic intervals.

The following illustrative examples show how the methods and apparatus discussed above can be used for monitoring, controlling, and recording performance of a storm water runoff network. These examples are meant to illustrate and not to limit the invention.

In one embodiment, and by way of example, the storm water management component 202 receives data including a forecast of large-scale precipitation a specified number of days in advance, which triggers a standby alert. In another embodiment, the storm water management component 202 monitors the forecast and confirms that the storm is still in the forecast. In still another embodiment, and at a specified time prior to the arrival of the storm, the storm water management component 202 sends an alert to a human operator (e.g., an email message) and the analysis engine 206 identifies a modification to the storage node 210 to be made in preparation for the arrival of the storm (e.g., to turn on at least one pump and to increase a rate of polling of a monitoring sensor 212); the command module 208 generates and sends a command to the storage node 210, the communications module 222 receives the command and transmits it to the controller 214, which executes the command, turning on the at least one pump and increasing the rate of polling of the monitoring sensor 212.

In another example, the storm water management component 202 receives data including a forecast of imminent precipitation. In one embodiment, the analysis engine 206 compares the precipitation forecast to a predetermined threshold and if a threshold is exceeded, determine that the container 216 should be purged before the precipitation. In another embodiment, the command module 208 generates and sends the command to purge the container 216 before the precipitation begins.

In an example of the storm water management component 202 responding to a system failure, if a pump motor burns out, the monitoring sensor 212 records that the pump is not running or a faulty current triggers a communication to the storm water management component 202. In one embodiment, the storm water management component 202 determines that the pump is not running when it should be or transmits a command to the storage node 210 to turn on the pump but the pump does not turn on and repeated attempts to turn the pump on fail. In another embodiment, the analysis engine 206 determines that a failure has occurred and that an alert should be sent to a human operator. In still another embodiment, the command module 208 generates and transmits a notification to the human operator; for example, the command module 208 may transmit an alert via email and cell phone to the human operator who then goes to the storage node 210 and corrects the problem.

In some embodiments of the methods and systems described herein, such methods and systems minimize peak storm water runoff, maximize groundwater recharge, and maximize water reuse. In other embodiments, these methods and systems increase the efficiency of the capacity of existing water-handling infrastructure by, for example, adding monitoring and control capabilities to distributed storm water management systems, by coordinating the performance of distributed infrastructure components, and by optimizing network performance to achieve storm water management goals.

It should be understood that the systems described above may provide multiple ones of any or each of those components and these components may be provided on either a standalone machine or, in some embodiments, on multiple machines in a distributed system.

The systems and methods described above may be implemented as a method, apparatus or article of manufacture using programming and/or engineering techniques to produce software, firmware, hardware, or any combination thereof. The techniques described above may be implemented in one or more computer programs executing on a programmable computer including a processor, a storage medium readable by the processor (including, for example, volatile and non-volatile memory and/or storage elements), at least one input device, and at least one output device. Program code may be applied to input entered using the input device to perform the functions described and to generate output. The output may be provided to one or more output devices.

Each computer program within the scope of the claims below may be implemented in any programming language, such as assembly language, machine language, a high-level procedural programming language, or an object-oriented programming language. The programming language may, for example, be LISP, PROLOG, PERL, C, C++, C#, JAVA, or any compiled or interpreted programming language.

Each such computer program may be implemented in a computer program product tangibly embodied in a machine-readable storage device for execution by a computer processor. Method steps of the invention may be performed by a computer processor executing a program tangibly embodied on a computer-readable medium to perform functions of the invention by operating on input and generating output. Suitable processors include, by way of example, both general and special purpose microprocessors. Generally, the processor receives instructions and data from a read-only memory and/or a random access memory. Storage devices suitable for tangibly embodying computer program instructions include, for example, all forms of computer-readable devices, firmware, programmable logic, hardware (e.g., integrated circuit chip, electronic devices, a computer-readable non-volatile storage unit, non-volatile memory, such as semiconductor memory devices, including EPROM, EEPROM, and flash memory devices; magnetic disks such as internal hard disks and removable disks; magneto-optical disks; and CD-ROMs. Any of the foregoing may be supplemented by, or incorporated in, specially-designed ASICs (application-specific integrated circuits) or FPGAs (Field-Programmable Gate Arrays). A computer can generally also receive programs and data from a storage medium such as an internal disk (not shown) or a removable disk. These elements will also be found in a conventional desktop or workstation computer as well as other computers suitable for executing computer programs implementing the methods described herein, which may be used in conjunction with any digital print engine or marking engine, display monitor, or other raster output device capable of producing color or gray scale pixels on paper, film, display screen, or other output medium. A computer may also receive programs and data from a second computer providing access to the programs via a network transmission line, wireless transmission media, signals propagating through space, radio waves, infrared signals, etc.

Having described certain embodiments of methods and systems for monitoring, controlling, and recording performance of a storm water runoff network, it will now become apparent to one of skill in the art that other embodiments incorporating the concepts of the disclosure may be used. Therefore, the disclosure should not be limited to certain embodiments, but rather should be limited only by the spirit and scope of the following claims.

What is claimed is:

1. A method for monitoring, controlling, and recording performance of a storm water runoff network comprises:
receiving, by a storm water management component, environmental data associated with a storage node;
analyzing, by the storm water management component, the received environmental data; and
modifying, by the storm water management component, an operation of the storage node, responsive to the analysis.

2. The method of claim 1 further comprising receiving, by the storm water management component, operational data associated with the storage node.

3. The method of claim 2 further comprising analyzing, by the storm water management component, the received environmental data and the received operational data.

4. The method of claim 1 further comprising modifying, by the storm water management component, a state of a valve in the storage node, responsive to the analysis.

5. The method of claim 1 further comprising modifying, by the storm water management component, a state of a pump in the storage node, responsive to the analysis.

6. The method of claim 1 further comprising modifying, by the storm water management component, a state of a gate in the storage node, responsive to the analysis.

7. A system for monitoring, controlling, and recording performance of a storm water runoff network, the system comprising:
a communications module executing on a computing device and receiving environmental data associated with a storage node;
an analysis engine executing on the computing device, analyzing the received environmental data and identifying a setting for the storage node; and
a command module executing on the computing device and directing the execution of a command to set the storage node to the identified setting responsive to the analysis.

8. The system of claim 7 further comprising a reporting component generating a report satisfying an environmental regulatory requirement.

9. The system of claim 7, wherein the communications module further comprises a transmitter sending, to the storage node, the generated command for execution.

10. The system of claim 7, wherein the communications module further comprises means for receiving, from at least one of the storage node and a second computing device, environmental data associated with the storage node.

11. A system for monitoring, controlling, and recording performance of a storm water runoff network, the system comprising:
a storage node storing runoff and comprising at least one monitoring sensor collecting environmental data associated with the storage node and a controller executing a command to operate the storage node; and
a storm water management component executing on a computing device, receiving, from the at least one monitoring sensor, the collected environmental data, analyzing the received data, and modifying an operation of at least one of the storage node and the at least one monitoring sensor, responsive to the analysis.

12. The system of claim 11, wherein the storage node further comprises a communications module in communication with the controller and with the storm water management component and receiving, from the storm water management component, a command to modify the operation of at least one of the storage node and the at least one monitoring sensor, and transmitting the command to the controller for execution.

13. The system of claim 11, wherein the storage node further comprises a communications module in communication with the at least one monitoring sensor and the storm water management component, receiving from the at least one monitoring sensor the collected environmental data, and transmitting the collected environmental data to the storm water management component.

14. The system of claim 11, wherein the at least one monitoring sensor further comprises a sensor detecting conditions associated with water in the storage node.

15. The system of claim 11, wherein the at least one monitoring sensor further comprises means for identifying at least one of a level of water in the storage node, a level of quality of water in the storage node, a water quality characteristic, a pumping rate of the storage node, a valve position of the storage node, and an electrical power status of the storage node.

16. The system of claim 11, wherein the at least one monitoring sensor further comprises means for collecting operational data associated with the storage node.

17. The system of claim 11, wherein the controller further comprises means for distributing water from the storage node.

18. The system of claim 11, wherein the controller further comprises means for collecting water in the storage node.

19. The system of claim 11, wherein the storm water management component further comprises means for receiving operational data from the storage node.

20. The system of claim 11, wherein the storm water management component further comprises a receiver receiving, from a second computing device, a second environmental data associated with the storage node.
